(19) United States
(12) Patent Application Publication
(10) Pub. No.: US 2024/0201003 A1
(43) Pub. Date: Jun. 20, 2024

(54) GRAVIMETRIC METERING DEVICE AND CONTROL METHOD THEREOF

(71) Applicant: PEGASO INDUSTRIES S.P.A., Borgoricco (PD) (IT)

(72) Inventor: Rinaldo PIVA, Borgoricco (PD) (IT)

(73) Assignee: PEGASO INDUSTRIES S.P.A., Borgoricco(PD) (IT)

(21) Appl. No.: 18/556,038

(22) PCT Filed: Apr. 19, 2022
(86) PCT No.: PCT/IB2022/053645

§ 371 Date: Oct. 18, 2023

(30) Foreign Application Priority Data
Apr. 19, 2021 (IT) 102021000009815

(51) Int. Cl. G01G 13/24; B29B 7/60; B29B 7/72; B29B 7/88

(52) U.S. Cl. CPC G01G 13/242; B29B 7/603; B29B 7/72; B29B 7/88

(57) ABSTRACT

A gravimetric metering device which is provided to add an additive material to a polymer material includes a hopper which to contain the additive material and a supply member which is provided downstream of the hopper in order to receive the additive material which is discharged from the hopper and to transport it towards a discharge opening which is connected to the polymer material, and a first and second weighing element which are provided to detect the weight of the additive material which is discharged from the gravimetric metering device.

The first weighing element is configured to detect a weight within a first maximum weighing range while the second weighing element is configured to detect a weight within a second maximum weighing range different from the first maximum weighing range.

### TECHNICAL FIELD

The present invention relates to a gravimetric metering device having the features set out in the preamble of the main claim and a method for controlling a gravimetric metering device.

In particular, the invention is used in a preferable though non-exclusive manner in the field of working plastics materials.

### TECHNOLOGICAL BACKGROUND

In the technical field set out above, it is widely known to produce objects made of polymer material starting from a polymer admixture comprising one or more polymer materials, for example, in the form of granules or flakes or powder, which are suitably mixed with appropriate additive materials capable of conferring on the final product specific chemical/physical or mechanical characteristics which are adequate for the objectives intended for the use thereof.

These additive materials can be both of an organic type and of an inorganic type with very different characteristics from each other, in terms of chemical composition or form or physical state.

Examples of additive materials which are commonly used in the working processes for the plastics materials are: stabilizing compounds, antioxidant compounds, colouring compounds, expanding compounds or, furthermore, compounds with barrier properties with respect to the passage of gas.

In a wide range of cases of working processes for plastics materials, the additive materials are added to the polymer admixture just before the moulding step or extrusion step and, to this end, gravimetric metering devices are commonly used and are typically positioned downstream of a supply hopper of a transforming machine, in which the polymer admixture is heated and dried.

In general terms, a gravimetric metering device comprises a hopper which contains the additive material to be added to the polymer admixture and a supply member, for example, a screw type supply member, which provides for introducing into the polymer admixture the additive material which is discharged from the hopper.

Furthermore, there are known gravimetric metering devices comprising a weighing unit which is associated with the hopper in order to detect over time the weight variation and therefore to determine the quantity of additive material discharged from the hopper and added to the polymer admixture.

In particular, the weighing unit may comprise a load cell, on which the hopper is supported (and possibly also the supply member) and is preferably connected to a control unit which, on the basis of the weight data received from the weighing unit, regulates in a suitable manner the functionality of the supply member, for example, by adjusting the rotation speed of the screw.

The Applicant has observed that the quantity of additive material which has to be added to the polymer admixture being processed may be very variable from one processing operation to another in accordance with the type of additive, the polymer material and the specific application of the finished product.

In particular, the Applicant has found that the quantity of additive material to be added to the polymer admixture may also vary by different orders of magnitude from one processing operation to another, changing from flow rates of a few tens of grammes per hour to several tens of kilogrammes per hour.

Sometimes, this may be required for the addition of the same additive material. In this sense, a particularly representative example is given by the addition of a colouring compound to a polymer admixture of polyethylene terephthalate (PET) for producing bottles, where in specific applications of semi-transparent bottles there is required a colouring metering of approximately 100 times less than the normal colouring metering for standard coloured bottles.

Moreover, the Applicant has observed that increasingly great metering precision of the additive material is required, with extremely small margins for error being allowed.

In these cases, the precision of the weighing unit takes on a fundamental importance so that even small measurement errors may bring about the waste of large quantities of final product, the stopping of production and the loss of time for restoring the correct functionality of the metering device.

Therefore, the Applicant has found that the metering of additive materials often becomes a particularly critical passage of the working process for the plastics materials and has established how, in order to comply with this requirement, it is often necessary to be provided with a specific metering member for each flow rate range.

The Applicant has thus felt the need for providing a gravimetric metering device which allows work to be carried out in metering ranges which are very high while, at the same time, maintaining a high level of metering precision.

In the present description and in the appended claims, the term “polymer material” is intended to be a material in which at least 50% and preferably at least 90% is formed by one or more polymers.

The polymer material may be any material which is suitable and normally used in working plastics materials. Preferably, it is a thermoplastic material, such as, for example, polyolefins, polyesters, polyamides and the copolymers thereof. A preferred example of polymer material is polyethylene terephthalate (PET).

Preferably, the polymer material is in granular form, this term being intended to be understood to be a plurality of solid elements which are different and separate from each other and which have dimensions and shapes which are suitable in accordance with the processing to be carried out and the material used, including the polymer material in powdered or flake form.

The term “additive material” is intended to be a material which is intended to be added to a polymer material before the forming thereof in order to modify one or more chemical/physical characteristics thereof.

In particular, the additive material is added to a polymer material at weight fractions less than 20%, more preferably less than 10%, with respect to the polymer admixture formed by the polymer material and the additive material.

The term “maximum weighing range” of a weighing element is intended to be the range within which the weighing element is configured to be able to carry out a weight measurement. Generally, this maximum weighing range starts from zero and extends up to a maximum weighing value, also known as the “full scale” value.

A weighing element further has a predetermined graduation or “scale”, which can generally be defined as the minimum difference between two values which can be measured with an adequate degree of precision. Generally, a weighing element which is provided with a higher maximum weighing range has a greater scale (that is to say, a greater difference between two values which can be measured precisely, therefore suitable for measuring weight variations which are relatively high) while, conversely, a weighing element which is provided with a smaller maximum weighing range has a finer scale which is more suitable for measuring small weight variations.

The term “nominal quantity” of additive material to be charged in a hopper is intended to be understood to be the quantity of material which it is necessary for the hopper to contain at the end of the operation for charging it with the additive material. The nominal quantity is sometimes expressed indirectly in terms of percentage of filling of the hopper.

### DISCLOSURE OF THE INVENTION

The problem addressed by the present invention is to provide a gravimetric metering device and a control method for a gravimetric metering device which are structurally and functionally configured to at least partially overcome one or more of the disadvantages set out above with reference to the cited prior art. This problem is solved by the present invention by means of a gravimetric metering device and a control method for it which are realised according to the appended claims.

In a first aspect thereof, therefore, the present invention is directed to a gravimetric metering device which is provided to add an additive material to a polymer material.

Preferably, the gravimetric metering device comprises:
a hopper which can contain the additive material,
a supply member which is provided to receive the additive material which is discharged from the hopper and to transport it towards a discharge opening which is connected to the polymer material,
a first and a second weighing element which are both provided to detect the weight of the additive material which is discharged from the gravimetric metering device.

Preferably, the first and second weighing elements are associated at least with the hopper.

Preferably, the first weighing element is configured to detect a weight within a first maximum weighing range and the second weighing element is configured to detect a weight within a second maximum weighing range.

Preferably, the first maximum weighing range is different from the second maximum weighing range.

In a second aspect thereof, the present invention is directed towards a method for controlling a gravimetric metering device which is provided to add an additive material to a polymer material.

Preferably, the gravimetric metering device is realised according to the above-mentioned first aspect and comprises a control unit which is associated with the supply member and the first and second weighing elements.

Preferably, the method comprises the step of defining a target flow rate of additive material to be supplied to the polymer material.

Preferably, the method comprises the step of defining a nominal quantity of additive material to be charged in the hopper capable of allowing the metering of the additive material with the target flow rate for an adequate minimum time. The adequate minimum time is intended to be evaluated in accordance with the type of processing but generally may be at least 15 minutes or at least 30 minutes or at least 60 minutes.

Preferably, the method comprises the step of comparing the weight of the nominal quantity of additive material with the first and second maximum weighing ranges and selecting one of the first and second weighing elements as the main weighing element.

The weight to be compared with the first and second maximum weighing ranges may also take account of the weight of the hopper or other components of the gravimetric device which charge the weighing elements. Preferably, the method comprises the steps of detecting by means of the main measuring element the weight at least of the hopper, determining, by means of the control unit, the flow rate of additive material discharged from the gravimetric metering device from the weight measurements detected by the main weighing element.

Preferably, the method comprises the step of comparing the flow rate of additive material thereby determined with the target flow rate and consequently regulating the supply member.

As a result of the features set out above, the gravimetric metering device of the present invention is provided with a first and a second weighing element having respective mutually different maximum weighing ranges.

It is thereby possible to define the metering operation using the most appropriate weighing element in accordance with the quantity of additive material required by the specific processing operation.

For example, the first weighing element may have a maximum weighing range which is suitable for controlling high flow rates of additive material while the second weighing element may have a maximum weighing range which is suitable for controlling additive material flow rates which are particularly low and which the first weighing element might not be able to monitor precisely owing to a lack of sensitivity of the instruments.

In this manner, the gravimetric metering device is able to precisely meter the additive material using the weighing element which is most suitable for the quantity of material required for the metering.

In at least one of the aspects set out above, the present invention may further have one or more of the additional preferred characteristics set out below.

In a preferred embodiment, the gravimetric metering device comprises a control unit which is provided to determine, on the basis of the weight detected by the first weighing element or by the second weighing element, the flow rate of the additive material which is discharged from the gravimetric metering device and to regulate the supply member in accordance with this flow rate.

Preferably, the supply member comprises a screw which extends between an outlet of the hopper and the discharge opening and a motor provided to rotate the screw.

Preferably, the control unit determines the functionality of the supply member by regulating the rotation speed of the screw.

In a preferred embodiment, the first weighing element and preferably also the second weighing element detect(s) the weight both of the hopper and of the supply member.

There is thereby obtained a greater level of precision when detecting the quantity of additive material which is effectively discharged in the unit of time from the gravimetric metering device because the additive material present in the supply member, in addition to the material present in the hopper, is also properly weighed.

Preferably, the hopper and the supply member are mounted on a plate which is in turn removably connected to a weighing unit comprising the first and the second weighing elements.

This feature affords rapid access to the weighing elements in the case of maintenance or replacement.

Preferably, the first and second weighing elements are positioned one adjacent to the other and are charged by the weight of the same components as the gravimetric metering device.

In some embodiments, the first maximum weighing range is at least double the second maximum weighing range, preferably at least 5 times greater than the second maximum weighing range.

In other embodiments, the first maximum weighing range is at least 10 times greater than the second maximum weighing range and preferably at least 50 times greater than the second maximum weighing range.

Preferably, the first and the second weighing elements are formed by load cells. In some embodiments, the selection of the main weighing element from the first and second weighing elements comprises the step of verifying whether the nominal quantity is within the first and second maximum weighing ranges and, if it is within only one of the first and second maximum weighing ranges, then this respective first or second weighing element is selected as the main weighing element.

In some embodiments, the selection of the main weighing element from the first and second weighing elements comprises the step of comparing the nominal quantity with a respective mean value both of the first and of the second maximum weighing ranges and selecting as the main weighing element the weighing element having the maximum weighing range with the mean value nearest the nominal quantity.

### BRIEF DESCRIPTION OF THE DRAWINGS

The features and advantages of the invention will be better understood from the detailed description of a preferred embodiment thereof, which is illustrated by way of non-limiting example with reference to the appended drawings, in which:

FIG. 1 is a schematic perspective view of a gravimetric metering device constructed according to the present invention;

FIG. 2 is a schematic side view of the gravimetric metering device of FIG. 1;

FIG. 3 is a schematic perspective view of a component of the gravimetric metering device of FIG. 1.

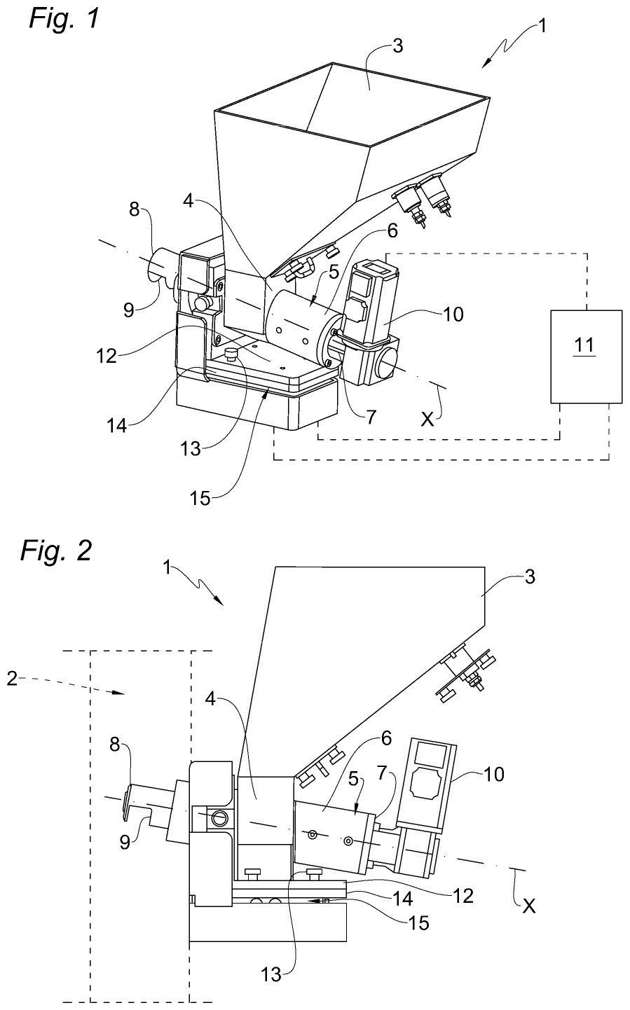

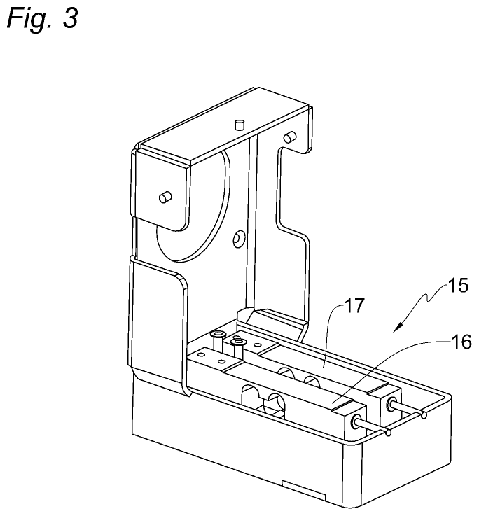

### PREFERRED EMBODIMENT OF THE INVENTION

With reference to the appended Figures, there is generally designated 1 a gravimetric metering device which is realised according to the present invention. The gravimetric metering device 1 is provided to add an additive material to a polymer material being supplied to a transforming machine, such as, for example, a pressing mould or an extruder, in which the polymer material is melted and moulded in order to form a desired article.

Preferably, the polymer material is in granular form and is from a drying hopper (which is conventional per se and is not illustrated in the appended Figures), where it is heated and dried before being supplied to the transforming machine.

In particular, the gravimetric metering device 1 introduces the additive material inside a pipe 2 which is depicted with broken lines in FIG. 2 and which connects the drying hopper to the transforming machine.

The polymer material is preferably PET and the additive material which is also in granular form is, for example, a stabilizing compound or a colouring compound.

The gravimetric metering device 1 comprises a hopper 3 which is connected by means of an outlet 4 which is formed on the base of the hopper 3 to a supply member 5. The supply member 5 comprises a screw which is received inside a cylinder 6 which extends in a longitudinal direction X between a first end 7 and a second end 8 where a discharge opening 9, from which the additive material is introduced into the pipe 2, is defined.

The screw of the supply member 5 is rotated by a motor 10 which is mounted at the first end 7 on the cylinder 6. In turn, the motor 10 is controlled by a control unit 11 so as to regulate the rotation speed of the screw and, consequently, the quantity of additive material per unit of time (in other words, the flow rate) which is present in the supply member 5 and transported towards the discharge opening 9.

The hopper 3 and the entire supply member 5 (cylinder, screw and motor) are mounted on a plate 12 which is L-shaped and which is in turn supported on a weighing unit 15. Preferably, the plate 12 is removably fixed, for example, with screws 13, to a corresponding plate 14 of the weighing unit 15.

The weighing unit 15 further comprises a first weighing element 16 and a second weighing element 17 which are formed, for example, by two respective load cells which are positioned one beside the other and which are configured to detect the weight of the plate 14 and of everything supported thereon.

The first weighing element 16 is configured to detect a weight within a first maximum weighing range, for example, between 0 and 100 kg, while the second weighing element 17 is configured to detect a weight within a second maximum weighing range, which is less than the first maximum weighing range, for example, between 0 and 20 kg.

The first and the second weighing elements 16, 17 are further independently connected to the control unit 11 which receives and processes the weight signals detected thereby with the main objective of establishing the quantity of additive material per unit of time discharged from the gravimetric metering device 1 and consequently to regulate the supply member 5 so as to comply with a predefined target flow rate value.

The gravimetric metering device 1 operates as follows.

The additive material to be metered inside the polymer material is charged in the hopper 3 in accordance with a predetermined percentage which is imposed (manually or automatically) in the control unit 11.

When the additive material inside the hopper 3 ends, or reaches a minimum level, the hopper 3 is charged with new additive material to be introduced into the pipe 2.

In accordance with the target flow rate of polymer material, the control unit 11 establishes the flow rate of additive material to be introduced into the pipe 2 during the passage of the polymer material and, consequently, regulates the rotation speed of the screw which transports the additive material.

Furthermore, still in accordance with the target flow rate of polymer material, there is imposed a nominal quantity of additive material to be charged in the hopper 3 so as to allow the metering of the additive material, for example, for at least one hour.

The most suitable weighing element for detecting the weight is then selected from the first and second weighing elements 16, 17.

The selected weighing element becomes the main weighing element for this specific processing operation and will be used by the control unit 11 in order to determine the real flow rate of additive material which is discharged from the gravimetric metering device 1.

In particular, the selection is carried out in accordance with the nominal quantity of additive material which in fact is correlated with the flow rate which the metering unit has to ensure. In greater detail, in order to precisely measure low flow rates, it is necessary for the scale of the weighing element to be finer, which generally involves a smaller maximum weighing range (that is to say, with a lower full scale). For this reason, it will be advantageous to impose a lower nominal quantity so as to allow the weight to be determined with this weighing element. Generally, this requirement does not involve any particular disadvantages because, when the target flow rate is reduced, the metering continuity can also be ensured for an adequate time with reduced nominal quantities of material.

Conversely, when the target flow rate of additive material required is high, it is necessary to have nominal quantities of additive material which are quite high and which require the use of the weighing element provided with the greater maximum weighing range, even if it is provided with a greater measurement scale (that is to say, which is less precise). However, this requirement also does not generally involve any particular disadvantages because the target flow rate is also high.

The weight of the hopper 3, the supply member 5 and the plates 12 and 14 can be detected in a substantially continuous manner by both the weighing elements 16, 17, but the regulation of the supply member 5 carried out by the control unit 11 is based only on the weight value detected by the main weighing element, which, by way of example, is identified below as being the first weighing element 16.

The control unit 11 determines the flow rate of additive material which is discharged from the gravimetric metering device 1 by calculating the reduction in weight detected over time by the main weighing element, in this case by the first weighing element 16. In fact, a weight variation detected by the weighing element may be attributed only to the variation of additive material present in the gravimetric metering device 1.

The flow rate value of additive material which is calculated is compared with the target flow rate value and, if necessary, the rotation speed of the screw is possibly adjusted.

The person skilled in the art will know how to apply suitable variants to the present invention in accordance with any specific requirements, all being included within the scope of protection defined by the appended claims.

For example, the metering device may have a number of weighing elements greater than two, each one having a respective maximum weighing range which is different from the other weighing elements so as to be able to use the most suitable weighing element for each target flow rate value.

1. A gravimetric metering device (1) which is provided to add an additive material to a polymer material, the device comprising:
a hopper (3) configured to contain the additive material,
a supply member (5) which is provided downstream of the hopper (3) in order to receive the additive material which is discharged from the hopper (3) and to transport it towards a discharge opening (9) which is connected to the polymer material,
a first weighing element (16) which is associated at least with the hopper (3) and which is provided to detect the weight of the additive material which is discharged from the gravimetric metering device (1) within a first maximum weighing range,
a second weighing element (17) which is associated at least with the hopper (3) and which is provided to detect the weight of the additive material which is discharged from the gravimetric metering device (1) within a second maximum weighing range,
wherein the first maximum weighing range is different from the second maximum weighing range.

2. The gravimetric metering device according to claim 1, further comprising a control unit (11) which is provided to determine, on the basis of the weight detected by the first weighing element (16) or by the second weighing element (17), a flow rate of the additive material which is discharged from the gravimetric metering device (1) and to regulate the supply member (5) in accordance with the flow rate.

3. The gravimetric metering device according to claim 1, wherein the supply member (5) comprises a screw which extends between an outlet (4) of the hopper (3) and the discharge opening (9) and a motor (10) for driving the screw, and the first and second weighing elements (16, 17) are provided to detect the weight of the supply member (5) and of the hopper (3).

4. The gravimetric metering device according to claim 1, wherein the first and second weighing elements (16, 17) are positioned one adjacent to the other and are charged by the weight of the same components as the gravimetric metering device (1).

5. The gravimetric metering device according to claim 1, wherein the first maximum weighing range is at least double the second maximum weighing range.

6. A method for controlling a gravimetric metering device (1) which is provided to add an additive material to a polymer material, the gravimetric metering device comprising:
a hopper (3) configured to contain the additive material,
a supply member (5), which is provided downstream of the hopper (3) in order to receive the additive material which is discharged from the hopper and to transport it towards a discharge opening (9) which is connected to the polymer material,
a first weighing element (16) which is associated at least with the hopper (3) and which is provided to detect the weight of the additive material which is discharged from the gravimetric metering device (1) within a first maximum weighing range,
a second weighing element (17) which is associated at least with the hopper (3) and which is provided to detect the weight of the additive material which is discharged from the gravimetric metering device (1) within a second maximum weighing range which is different from the first maximum weighing range,
a control unit (11) which is associated with the supply member (5) and with the first and second weighing elements (16, 17),
wherein the method comprises:
defining a target flow rate of additive material to be supplied to the polymer material,
defining a nominal quantity of additive material to be charged in the hopper capable of allowing the metering of the additive material with the target flow rate for an adequate minimum time,
comparing the nominal quantity of additive material with the first and second maximum weighing ranges and selecting one from the first and second weighing elements (16, 17) as the main weighing element,
detecting, by means of the main measuring element, the weight of at least the hopper (3),
determining, by means of the control unit (11), the flow rate of additive material which is discharged from the gravimetric metering device (1) from the weight measurements detected by the main weighing element (16; 17), and
comparing the flow rate of additive material determined by means of the control unit with the target flow rate and consequently regulating the supply member (5).

7. The method according to claim 6, wherein the selection of the main weighing element from the first and second weighing elements comprises:
verifying whether the nominal quantity is within the first and second maximum weighing ranges and,
if the nominal quantity is within only one of the first and second maximum weighing ranges, then selecting the respective first or second weighing element as the main weighing element.

8. The method according to claim 6, wherein the selection of the main weighing element from the first and second weighing elements comprises:
comparing the nominal quantity with a respective mean value of each of the first and second maximum weighing ranges and
selecting as the main weighing element the weighing element having the maximum weighing range with the mean value nearest the nominal quantity.
